(19) United States
(12) Patent Application Publication
(10) Pub. No.: US 2004/0176965 A1
(43) Pub. Date: Sep. 9, 2004

(54) Durable goods equipment availability and usage system and method

(75) Inventors: John J. Winch, Dayton, OH (US); Daniel A. Schoch, Minster, OH (US)

Correspondence Address: RANDALL J. KNUTH P.C., 3510-A STELLHORN ROAD, FORT WAYNE, IN, 46815-4631, US

(73) Assignee: The Minster Machine Company

(21) Appl. No.: 10/382,276

(22) Filed: Mar. 5, 2003

(51) Int. Cl. G06F 17/60

(52) U.S. Cl. 705/1; 705/400

(57) ABSTRACT

An apparatus and method for monitoring, comparing, calculating, storing, transmitting, and billing durable goods operating usage fee for equipment based on the type amount and location of usage amount of usage, location of usage, of the equipment. Based on the type of usage, a discount or penalty can be added to the equipment usage fee based upon predetermined depreciation levels. Also, an equipment availability fee can be added to the equipment usage fee.

### BACKGROUND OF THE INVENTION

1. Field of the Invention

The present invention relates to a method and apparatus for calculating an equipment usage fee, such as for the use of durable goods equipment (having a useful life of three years or longer), for example mechanical presses.

2. Description of the Related Art

To purchase durable goods equipment, such as a press, a purchaser or operation must have adequate capital. Durable goods equipment can be expensive and the initial price of the equipment could keep companies from competing in the marketplace. An option for a company that can not afford the capital to purchase the equipment is to rent or lease the equipment or enter into production partnership with the durable goods manufacturer. A potential problem for the manufacturer or owner of the equipment is that the renter can operate the equipment irregularly, roughly or carelessly which will depreciate and cause wear to the equipment faster than if the equipment was operated smoothly and with reasonable care. This increased rate of depreciation causes the owner to prematurely lose the value of his asset, and thereby, also lose future profits because the equipment will have to be repaired or replaced earlier than normally expected.

The renter operator has no incentive to use the equipment properly because there is no benefit or discount for using the equipment properly. Also, there is no penalty for misusing the equipment or using the equipment in an unconventional manner because the owner may not find out that misuse occurred until after the renter has returned the equipment. With some equipment, the owner is unable to stop the renter from using the equipment without physically going to the location of the equipment and retrieving the equipment. Also, the inability to stop use of the equipment from a remote location is a concern for the owner when the renter has not paid for the on going use of the equipment. This inability to stop use of the equipment not only costs the owner money but also costs time in traveling to the location of the equipment. The present invention protects the investment of the equipment owner from having the renter depreciate the equipment faster than normal without adequate compensation, as well as, the renter using the equipment without paying for continuing use of the equipment.

### SUMMARY OF THE INVENTION

Generally, the invention is an apparatus and method that provides a means for durable goods producers to gain access to capitol equipment needed for the venture, by either leasing equipment as available or by partnering with a durable goods manufacturer or licensor with either program governed by a scaled leasing or a profit sharing partnership rate.

The present invention comprises, in one form thereof, an apparatus for calculating a composite usage fee for equipment wherein the usage fee is calculated based on the type of usage of the equipment, as well as, the amount of usage of the equipment. The apparatus has a monitoring means connected to the equipment for monitoring usage of the equipment and creating equipment usage data. A comparing means is connected to the monitoring means for comparing the equipment usage data to a predetermined depreciation level to determine a corresponding depreciation level value. A calculating means is connected to the comparing means for calculating an equipment usage fee wherein the equipment usage fee is calculated by combining the equipment usage data and the corresponding depreciation level value. The system may include an optional user display of current usage rate to allow the user to make real time equipment operation changes if rate change increases are significant.

The present invention comprises, in another form thereof, an apparatus for calculating a usage fee for equipment wherein the usage fee is calculated based on the type of usage, as well as, the amount of usage of the equipment. Also, based on the type of usage, a penalty or discount is applied to the equipment usage fee. The apparatus has a monitoring means connected to equipment for monitoring usage of the equipment and creating equipment usage data. A comparing means is connected to the monitoring means for comparing the equipment usage data to a predetermined depreciation level to determine a corresponding depreciation level value. A four light level alert system may be utilized to give real time feedback of usage rate to the operator. A calculating means is connected to the comparing means for calculating an equipment usage fee wherein the equipment usage fee is calculated by combining the equipment usage data and the corresponding depreciation level value. Furthermore, the calculating means increases or decreases the equipment usage fee factors based on the corresponding depreciation level value after the equipment usage fee is initially calculated.

The present invention comprises, in yet another form thereof, an apparatus for calculating a usage fee for a press wherein the usage productivity reel ability fee is calculated based on the type of usage of the press and the amount of usage of the press. The apparatus comprises a press and a monitoring means connected to the press wherein the monitoring means creates press usage data. A calculating means is connected to the monitoring means for calculating a press usage fee based on the press usage data.

The present invention comprises, in yet another form thereof, a method for calculating a usage fee for equipment wherein the usage fee is calculated based on the type of usage of the equipment, as well as, the amount of usage of the equipment. The first step of the method is providing equipment. The second step of the method is monitoring the equipment. The third step of the method is creating equipment usage data based on the monitoring of the equipment. The fourth step of the method is comparing the equipment usage data to a predetermined depreciation level to determine a corresponding depreciation level value. The fifth step of the method is calculating an equipment usage fee by combining the equipment usage data and the corresponding depreciation level value.

The present invention comprises, in yet another form thereof, a method for calculating a usage fee for equipment wherein the usage fee is calculated based on the type of usage of the equipment, as well as, the amount of usage of the equipment. Furthermore, based on the type of usage of the equipment, a penalty or discount is applied to the usage fee. The first step of the method is providing equipment. The second step of the method is monitoring the equipment. The third step of the method is creating equipment usage data based on the monitoring of the equipment. The fourth step of the method is comparing the equipment usage data to a predetermined depreciation level to determine a corresponding depreciation level value. The fifth step of the method is calculating an equipment usage fee by combining the equipment usage data and the corresponding depreciation level value. The equipment usage fee is then either increased or decreased based on the corresponding depreciation level value after the equipment usage fee is initially calculated.

The present invention comprises, in yet another form thereof, a method for calculating a usage fee for a press wherein the usage fee is based on the type of responsible, reasonable, or reliable usage of the press, as well as, the amount of usage of the press. The first step of the method is providing a press. The second step of the method is creating press usage data for the press. The third step of the method is calculating a press usage fee based on the press usage data.

The present invention comprises, in yet another form thereof, a method for calculating a usage fee for equipment wherein the usage fee is calculated using an equipment availability fee, the type of usage of the equipment and the amount of usage of the equipment. The first step of the method is providing equipment. The second step of the method is monitoring the equipment. The third step of the method is creating equipment usage data based on the monitoring of the equipment. The fourth step of the method is comparing the equipment usage data to a predetermined depreciation level to determine a corresponding depreciation level value. The next step of the method is calculating an equipment usage fee by combining the equipment usage data and the corresponding depreciation level value and then the composite equipment usage fee is increased or decreased after the equipment usage fee is calculated based on the corresponding depreciation level value. The equipment usage fee is then increased by an equipment availability fee.

An advantage of the present invention is that durable goods equipment, such as a press, can be leased, licensed, or rented to a client who is unable to procure the start-up capital to purchase the equipment while protecting the equipment.

Another advantage of the present invention is that the owner of the equipment can charge the renter of the equipment based on the type of usage of the equipment, as well as, the amount of usage of the equipment as well as immediate availability of the equipment and not merely on the amount of usage of the equipment. By charging the renter based on the type of usage, the owner is justly compensated for the equipment being unnecessarily depreciated by the renter, if the renter is using the equipment in a manner that will depreciate the equipment, or consuming the usable life of the equipment faster than the owner's desired rate.

A further advantage of the present invention is that the owner can add a penalty fee to the equipment usage fee if the renter uses the equipment in manner inconsistent with or worse than the owner's desired use of the equipment. Also, the owner can subtract a discount amount from the usage fee for a renter who uses the equipment in a manner consistent with or better than the owner's desired use of the equipment.

Yet, another advantage of the present invention is that the owner can lock or deactivate the equipment from a remote location to stop usage of the equipment by the renter who has not paid for prior use of the equipment or is using the equipment contrary to the owner's authorized use of the equipment. Also, the owner can unlock or authorize the equipment from a remote location upon payment of the fee for usage of the equipment by the renter or the renter agreeing to use the equipment in a manner authorized by the owner.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a diagrammatic view of one form of the present invention;

FIG. 2 is a diagrammatic view of another form of the present invention;

FIG. 3 is a flow chart of one form of the present invention. In the example shown, the base rate $X for press usage increase for use in higher vibration severity zones. The dotted line portion shows use and therefore cost. Thus, after vibration severity effects created during press use are diminished. Even though press speed has increased, the base usage rate has decreased, therefore decreasing costs.

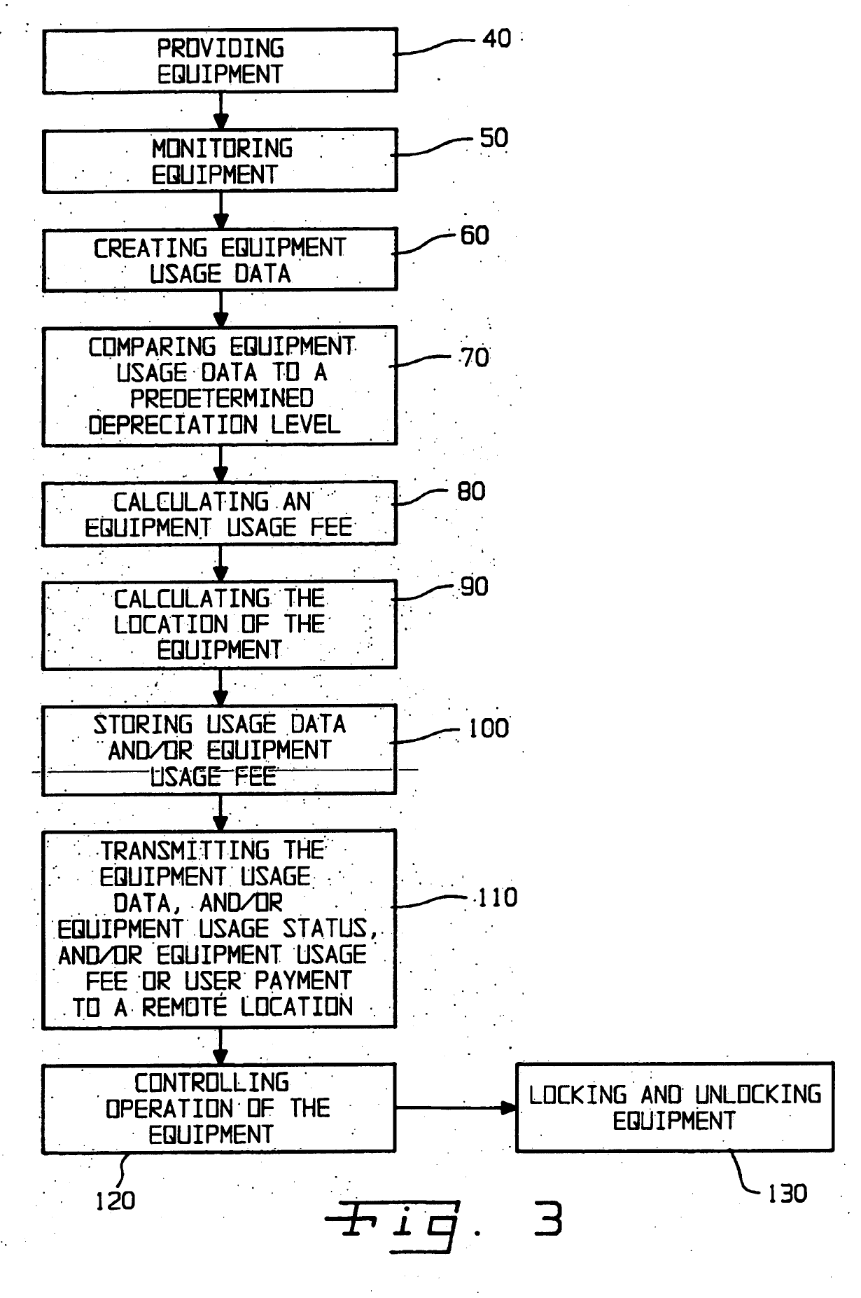

FIG. 4 is a diagrammatic view of another form of the present invention; and

FIG. 5 is an example of how a press usage rate increases for use of a press in increasing vibration severity zones. In the example shown, the base rate $X for press usage increases for use in higher vibration severity zones. The dotted line portion shows use and therefore cost of use, after vibration severity effects created during press use are diminished. Even though press speed has increased, the base usage rate has decreased, therefore decreasing costs.

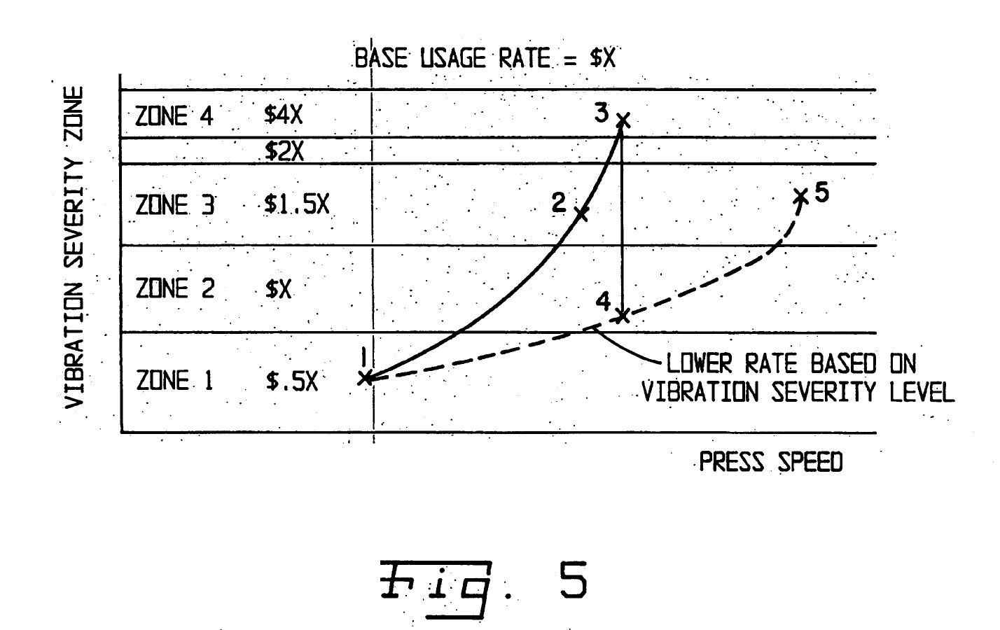

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

The present invention calculates an equipment usage fee based on equipment usage data that includes the type of usage of the equipment, as well as, the amount of usage of the equipment.

In one form of the present invention, a penalty fee is added to the equipment usage fee if the lessee, licensee, or renter (for ease of description and more gradually hereinafter termed operator) exceeds predetermined use thresholds established by the owner. The thresholds correlate to different levels of depreciation, use degradation or wear of the equipment. The equipment usage data gathered from the equipment can also be used to identify low risk and high risk customers/operator based on the customers usage of the equipment. If the customer is a high risk operator, that customer may pay more for the use of the equipment, than a low risk operator would pay to use the same equipment.

The apparatus used to calculate the equipment usage fee can be used with presses, or other durable goods and/or tools used in the machine industry, vehicles, hand tools, electronic devices, mechanical devices, or any other device where the calculation of a usage fee would be desired based on the type and amount of use of the equipment and not only on the amount of time the equipment is utilized. The apparatus is utilized to determine which of the particular depreciation levels (thresholds) the equipment usage is within and based on the depreciation level for which the equipment use is within, a fee will be applied to the amount of usage within that particular depreciation level.

An example of calculating an equipment usage fee based on the type and amount of equipment usage would be if depreciation levels were established for the use of a mechanical press wherein the first depreciation level is 0-50 strokes per minute, a second depreciation level is 51-100 strokes per minute, the third depreciation level is 101-150 strokes per minute, and the fourth depreciation level is 151-200 strokes per minute. If the owner of the press determines that the higher the strokes per minute, the faster the press will depreciate, then the owner can apply different increasing amounts of fees for use of the press from depreciation level 1 to depreciation level 4. The owner may determine that the charge for utilizing the press in depreciation level 1 would be, for example 10 cents per stroke, 20 cents per stroke for the use of the press in depreciation level 2, 30 cents per stroke for the use of the press in depreciation level 3, and 40 cents per stroke for use of the press in depreciation level 4. The ability to calculate and charge equipment usage fee based on different depreciation levels and use allows the owner to protect the press against depreciation of the press faster than the owner of the press desires. If the customer or owner does not want to use different depreciation levels to calculate the press usage fee, a flat fee, such as per stroke, use, or length of time such as month or year, can be utilized as well.

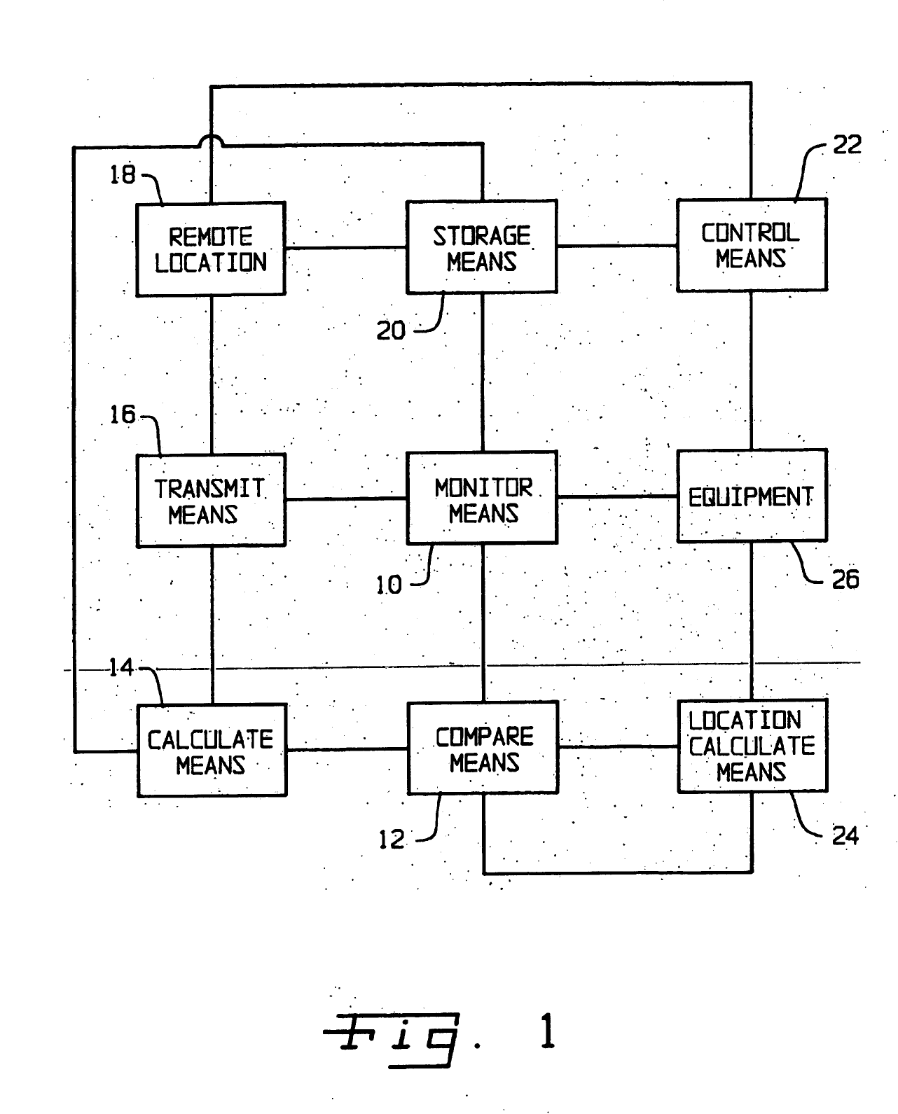

Referring now to the drawings and particularly to FIG. 1, there is shown an apparatus for calculating a usage fee for equipment based on the type of use of the equipment in addition to the amount of usage of the equipment. The apparatus includes a monitoring means 10. Monitoring means 10 is connected to equipment 26 to monitor usage of equipment 26 and create equipment usage data based on the usage of equipment 26. Monitoring means 10 can monitor many aspects of equipment 26 including, but not limited to, vibration level, vibration severity level, operating speed, operating torque, operating temperatures, operating pressure, operating deflection, operating time, operating noise level, and the number of parts produced to calculate the equipment usage fee.

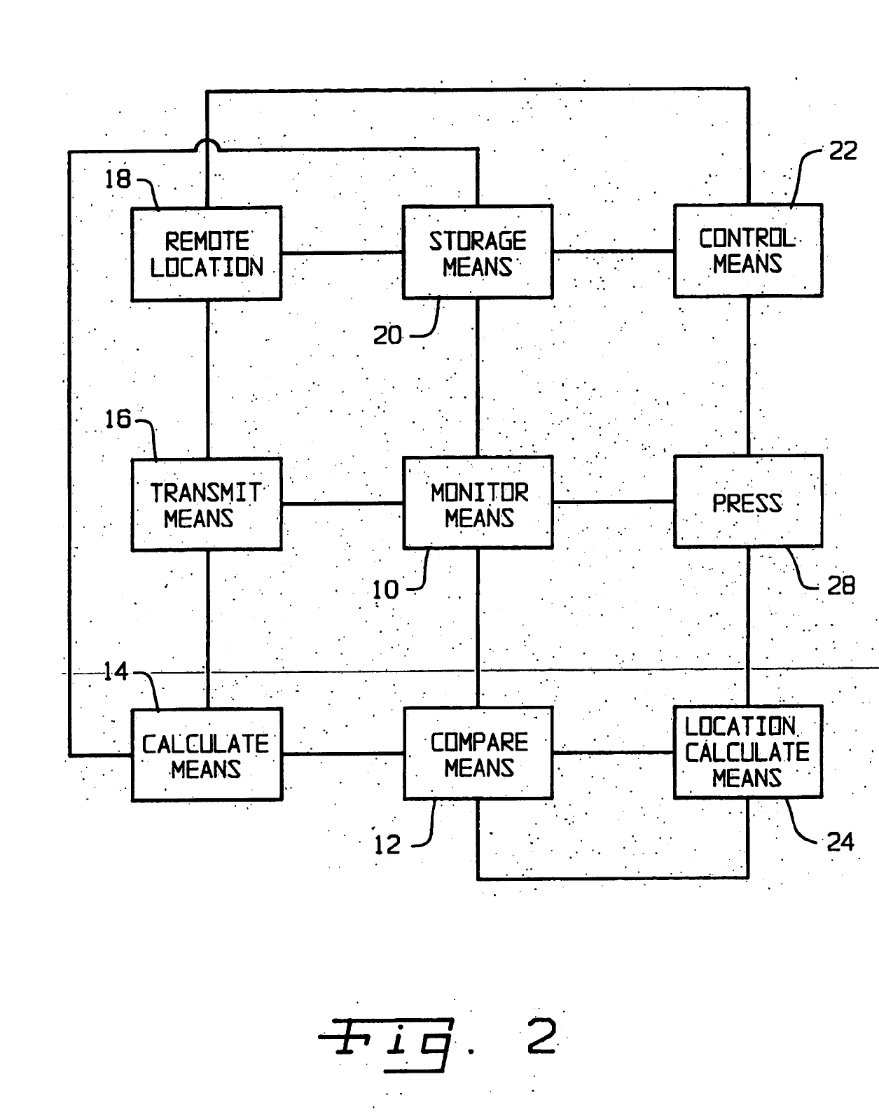

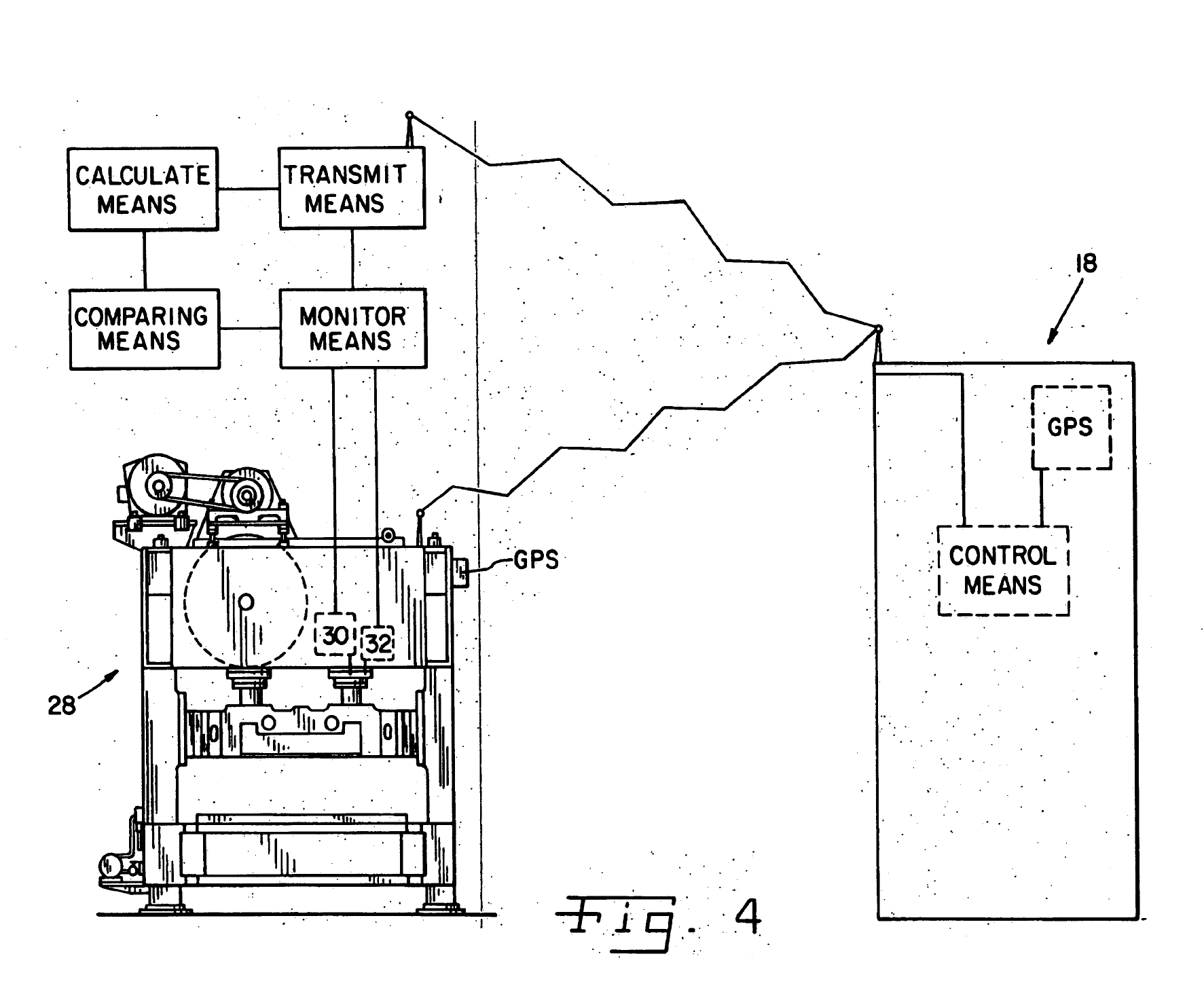

In another form of the present invention, as shown in FIG. 2, equipment 26 is a press 28. Monitoring means 10 is connected to press 28 to monitor vibration level, vibration severity level, operating speed, operating torque, operating temperatures, operating pressures, operating deflections, operating noise level, the number of parts produced and the number of press strokes. An accelerometer 30 is connected to press 28 to calculate the acceleration of the press components as shown in FIG. 4. Load sensors 32 are connected to press 28 to calculate the force on the press components as shown in FIG. 4. Pressure sensors and temperature sensors can be utilized as well based on the particular criteria the owner of press 28 wants to monitor.

An example of equipment usage data being used with the depreciation levels as described earlier in this application to calculate an equipment usage fee is if the press usage was 1,000 strokes per minute at depreciation level 1, 2,000 strokes at depreciation level 2, 2,500 strokes at depreciation level 3, and 1,500 strokes at depreciation level 4. Using the number of strokes for each depreciation level combined with the cost per strokes per minute corresponding with each depreciation level that applies to the press usage, an equipment usage fee will be calculated. Using the cost structure for the four depreciation levels as described earlier in this application, the cost for 1,000 strokes at depreciation level 1 would be $100.00 (1,000 strokes×$0.10 per stroke). The cost for 2,000 strokes at depreciation level 2 would be $400.00 (2,000 strokes×$0.20 per stroke). The cost for 2,500 strokes at depreciation level 3 would be $750.00 (2,500 strokes×$0.30 per stroke). The cost for 1,500 strokes at depreciation level 4 would be $600.00 (1,500 strokes×$0.40 per stroke). Totals for each depreciation level are added together and the total cost for the press usage described in this example is $1,850.00. This is an example and not meant to be limiting to the present invention.

A location calculating means 24 is in communication with equipment 26 to calculate the location of equipment 26. The location of equipment 26 is also utilized to calculate the equipment usage fee. Location calculating means 24 is a Global Positioning System but other types of equipment locating devices can be utilized as well.

Location calculating means 24 is connected to comparing means 12 and is utilized to monitor the location of equipment 26. Based on the location of equipment 26, comparing means 12 accesses the look-up table and determines the corresponding location value. The location value is transferred to calculating means 14 and the location value is combined with the equipment usage fee. Based on the location of equipment 26, the equipment usage fee either increases, decreases, or stays the same as established by the owner. If equipment 26 is utilized in a high risk geographic zone, the equipment usage fee will increase. A high risk geographic zone would be a location where equipment 26 is likely to be damaged or stolen. If equipment 26 is utilized in a low risk geographic zone, the equipment usage fee will decrease. A low risk geographic zone is a location where equipment 26 is less likely to be damaged or stolen than a high risk geographic zone. Also, the owner of equipment 26 can establish no-use geographic zones for which equipment 26 is not to be utilized at any time. If the customer ignores the owner's instructions and utilizes equipment 26 in a no-use geographic zone, equipment 26 could be destroyed or stolen.

To stop the operator from utilizing equipment 26 contrary to the owner's agreed to instructions, a controlling means 22 is in communication with equipment 26 for controlling operation of equipment 26 from a remote location. Controlling means 22 can be directly connected to equipment 26 or can be wirelessly connected to equipment 26. Controlling means 22 is connected to a network, such as the Internet, allowing the owner working from a remote location 18 to send a command to controlling means 22 to lock equipment 26 which disables usage of equipment 26, as well as, send a command to controlling means 22 to unlock equipment 26 which enables usage of equipment 26. Controlling means 22 can also be used to control the functioning of equipment 26, such as the speed at which equipment 26 is used. Remote location 18 can be a corporate headquarters or an accounting department of the owner's company. Controlling means 22 is utilized if it is determined that equipment 26 is being used in a no-use geographic zone or against the owner's instructions. Also, if the customer is defaulting on payment of the equipment usage fee for past use of equipment 26, the owner can lock equipment 26 from remote location 18 so that the customer can no longer utilize equipment 26. If the customer comes into compliance with the owner's request for payment of past usage of equipment 26, the owner can unlock equipment 26 from remote location 18.

Monitoring means 10 can be wireless monitoring sensors in communication with equipment 26. The wireless monitoring sensors provide real-time feedback to remote location 18. Also, a display (not shown) can be connected to equipment 26 and located in the customer's view. The display can show feedback from monitoring means 10 to the customer, such as the current level of usage and any discount or penalty that is currently being applied to the equipment usage fee based on the current usage of equipment 26. This configuration will allow the customer to view the accumulation of the equipment usage fee and modify the usage of equipment 26 based on the amount the customer wants to pay to the owner of equipment 26.

A comparing means 12 is connected to monitoring means 10 to compare the equipment usage data from monitoring means 10 to predetermined depreciation levels to determine which corresponding depreciation level each usage of equipment 26 falls within and a depreciation level value will be combined with each usage. Comparing means 12 is a processor, such as a Pentium 300 MHz or faster, or a programable logic controller. Predetermined depreciation levels are established by the owner of equipment 26. As described earlier, each of the depreciation levels correspond to the amount of depreciation to equipment 26 by utilizing equipment 26 at a particular depreciation level. Comparing means 12 utilizes a look-up table that includes the range of usage values for each predetermined depreciation level and a corresponding depreciation level value for equipment usage within each predetermined depreciation level. Comparing means 12 compares equipment usage data to the predetermined depreciation levels to determine which depreciation level the equipment usage data is within. Once the appropriate depreciation level is established, comparing means 12 utilizes the look-up table to look up the corresponding depreciation level value which will be used in the calculation of the equipment usage fee.

A calculating means 14 is connected to comparing means 12 for calculating the equipment usage fee. Calculating means 14 is a processor, such as a Pentium 300 MHz or faster, or an arithmetic logic controller. The equipment usage fee is calculated by combining the equipment availability data, equipment usage data, and the corresponding depreciation level value. The depreciation level value is a cost per use of the equipment at a particular depreciation level. The equipment usage data is multiplied by the corresponding depreciation level value to calculate the equipment usage fee. The equipment usage data is not limited to being multiplied by the corresponding depreciation level value to calculate the equipment usage fee and other ways of combining the equipment usage data with the corresponding depreciation level value can be utilized as well, such as the equipment usage data can be added, subtracted, divided or combined in some other manner with the corresponding depreciation level value to calculate the equipment usage fee.

The calculation of the equipment usage fee can be completed monthly, weekly, daily, in real-time with the usage of equipment 26. Once the equipment usage fee is calculated, penalties or discounts can be applied to the equipment usage fee based on the depreciation level value for each usage of equipment 26. If the depreciation level value corresponds to a depreciation level that the owner considers higher than normal, a penalty fee is added to the equipment usage fee. If the depreciation level value is at or lower than the expected depreciation for equipment 26, a discount amount is subtracted from the equipment usage fee. Also, based on the customer's prior depreciation level values, a discount amount can be subtracted from the current equipment usage fee for a good customer and a penalty fee can be added to the equipment usage fee for a hard using or equipment abusing customer hereinafter termed a marginal customer. A good customer is defined as a customer who utilizes equipment 26 within the owner's desired range of usage of equipment 26, wherein a bad customer is defined as a customer who utilizes equipment 26 in a manner not within the owner's desired range of usage of equipment 26. The use of a penalty or discount is an option for the owner and is not meant to be limiting to the present application.

Predetermined depreciation levels can relate to a single factor, such as speed. Also, a combination of factors can be utilized to establish the predetermined depreciation level, such as a combination of speed and vibration. The type and number of factors utilized to determine the predetermined depreciation levels are based on the importance of those factors to the owner of equipment 26. The predetermined depreciation levels as described earlier in this application were linear, but non-linear predetermined depreciation levels can be utilized as well. By being non-linear, the predetermined depreciation levels do not need to increase by equal amounts per each predetermined depreciation level. An example of this would be if equipment 26 is press 28. The owner may determine that the charge for utilizing press 28 at depreciation level 1 would be 10 cents per stroke, 15 cents per stroke for the use of press 28 at depreciation level 2, 40 cents per stroke for the use of press 28 at depreciation level 3, and 85 cents per stroke for the use of press 28 at depreciation level 4. Therefore, linear and non-linear increases in depreciation levels as predetermined by the owner is utilized in the present application.

In one form of the present invention, calculating means 14 is located at remote location 18. In another form of the present invention, calculating means 14 can be located at the location of equipment 26.

A storage means 20 is connected to monitoring means 10 for storing the equipment usage data created by monitoring means 10. Storage means 20 can also be connected to calculating means 14 for storing the equipment usage fee calculated by calculating means 14. Storage means 20 in one form is an Electrically Erasable Programmable Read-Only Memory (EEPROM) but an alternate means of storage, such as a flash memory or other non-volatile memory can be utilized as well. Storage means 20 can be removed by the owner and can be manually transported to remote location 18. Storage means 20 is in a housing (not shown) that is tamper resistant to eliminate any attempt by the customer utilizing equipment 26 to modify or eliminate the data stored on storage means 20.

A transmitting means 16 is connected to monitoring means 10 for transmitting the equipment usage data from monitoring means 10 to remote location 18. Transmitting means 16 is a connection to a network, such as the Internet, so that the equipment usage data can be transmitted from monitoring means 10 to remote location 18 where the equipment usage fee can be calculated at remote location 18. In one form of the present invention, a Radio Frequency (RF) tag or bar code can store equipment usage data from equipment 26 that can be read at the location of equipment 26 or upon return of equipment 26 to remote location 18. In another form of the present invention, transmitting means 16 is connected to calculating means 14 for transmitting the calculated equipment usage fee to remote location 18.

In one form of the present invention, once the equipment usage fee is calculated, an invoice is mailed or can be automatically e-mailed to the company or person using equipment 26. In another form of the present invention, the equipment usage fee can be automatically deducted from a bank account established and funded by the operator of equipment 26. In yet another form of the present invention, the equipment usage fee can be charged to the company credit card of the company operating the equipment. In yet another form of the invention, a display means may be incorporated into the monitor means 10 visual to display system information and in particular, show operator usage fee information and totals.

Another form of the present invention, is a method for calculating a usage fee for equipment, such as a mechanical press, based on the type of usage of the equipment in addition to the amount of time the equipment is used. The first step of the method is providing equipment (40). The equipment is a press, but can be other machine tools, as well as, vehicles or any other device that is rented to a customer and an owner would prefer to have a usage fee calculated based on the type of usage in addition to the amount of usage of the equipment. The second step of the method is monitoring the equipment (50). The equipment is monitored either by being directly connected to a monitoring device or using wireless monitoring sensors with the equipment which provides real-time feedback to a remote location. The third step of the method is creating equipment usage data (60) based on the monitoring of the equipment. The equipment usage data is based on the type of usage of the equipment such as the usage speed of the equipment and any negative effects caused by running the equipment at that particular speed in combination with the amount of usage of the equipment. The fourth step of the method is comparing the equipment usage data to at least one predetermined depreciation level (70) to determine a corresponding depreciation level value. The predetermined depreciation levels are established by the owner of the equipment and a corresponding depreciation level value is assigned to each depreciation level for use in calculation of the equipment usage fee. The step of the method is calculating an equipment usage fee (80) which is completed in an example embodiment by multiplying the equipment usage data by the corresponding depreciation level value. Other functions useful to calculate the equipment usage fee may include other mathematical and/or matching and/or comparing functions including statistical or probability models. The range of functions useful to calculate the equipment usage fee is not limited in this invention to those described. A penalty fee or discount amount can be applied to the equipment usage fee.

A further step of the method is calculating the location of the equipment (90) for calculation of the equipment usage fee when the location of the equipment is utilized to calculate the equipment usage fee. If the location of the equipment is a good location as pertaining to crime or authorized and designated plant site, boundary then the equipment usage fee may be decreased. If the equipment is in a bad neighborhood for crime, the equipment usage fee may be increased. Similar fee increase are possible, if for example, attempts were made to use mobile equipment in non authorized plant sites, areas, or outside of designated boundaries occur.

Another step of the method is storing at least one of the usage data and the equipment usage fee (100). The storing of the usage data and/or equipment usage fee protects the owner from losing any equipment usage data or accrual of an equipment usage fee that may get lost in a remote transmission from the equipment to the remote location. The owner can physically remove the storing device and retrieve the information from the storage device.

Other steps of the method include transmitting at least one of the equipment usage data and the equipment usage fee to a remote location (110). The remote location is the accounting department for the owner's company or a person's office if that person is in charge of working with the equipment usage data and/or fee. Another step of the method is controlling operation of the equipment from a remote location (120). This control allows the owner of the equipment to start and stop the equipment from being used, as well as, control the functions of the equipment.

Another step of the method is locking and unlocking or abling/disabling the equipment (130). Locking the equipment stops the customer from using the equipment permanently until the owner unlocks the equipment either remotely or going to the customer's facility and unlocking the equipment.

Another form of the present invention, is a method for calculating a usage fee based on the type of use of the equipment, as well as, the available use of the equipment. The equipment can be a press. There is a fee to the customer for the availability of the equipment. This availability fee is charged to the customer even if the customer never uses the equipment. The availability fee is charged to the customer for the availability with the option of using the equipment. If the equipment is used, an equipment usage fee is calculated, any penalties or discounts are applied to the calculated equipment usage fee and the equipment availability fee is added to the calculated equipment usage fee. The first step of the method is providing the equipment (40). The second step of the method is monitoring the equipment (50). The next step of the method is creating equipment usage data (60) based on the monitoring of the equipment. The next step of the method is comparing the equipment usage data to at least one predetermined depreciation level (70) to determine a corresponding depreciation level value. The next step of the method is calculating the equipment usage fee (80) by combining the equipment usage data and the corresponding depreciation level value. The equipment usage fee is then either increased by a penalty fee or decreased by a discount amount based on the corresponding depreciation level value after the equipment usage fee is calculated. The equipment usage fee is then increased by the equipment availability fee. The location of the equipment is calculated (90) and based on the location of the equipment, the equipment usage fee may be increased for a bad or unauthorized location or decreased for a good authorized location of the equipment.

Other steps of the method include storing the equipment usage data and/or equipment usage fees (100). Another step of the method is transmitting the equipment usage data and/or the equipment usage fee to a remote location (110). Another step of the method is controlling operation of the equipment (120). One way to disable/enable control the operation of the equipment is locking and unlocking the equipment (130). Once the equipment is locked, the customer can not use the equipment until the owner of the equipment either remotely unlocks the equipment or visits the facility and manually unlocks the equipment at the facility.

The apparatus in operation is connected to press 28, which is rented or leased by a customer from the owner of durable goods (e.g., press 28.) Press 28 is transferred to the customer's facility. Monitoring means 10 monitors the usage of press 28. Comparing means 12 compares the press usage data from monitoring means 10 and compares it to at least one predetermined depreciation level to determine a corresponding depreciation level value. Based on the depreciation level value, calculating means 14 calculates a press usage fee. The press usage fee is calculated by a functional relationship for example combining the press usage data from monitoring means 10 with the corresponding depreciation level value from comparing means 12. Transmitting means 16 can be utilized to transmit the press usage data and/or press usage fee to remote location 18 at any time. Remote location 18 is the owner's accounting department or some other area that the owner decides will be responsible for the collection of the press usage fee.

Also, location calculating means 24 can be utilized to determine the location of the press and based on the location of the press, transfer the location data to comparing means 12 to either increase, decrease or keep the press usage fee the same. Storage means 20 is connected to monitoring means 10 and/or calculating means 14 for storage of the press usage data and/or the press usage fee. Storage means 20 is removable and therefore the owner can manually transfer the storage means to any location necessary to read the data from storage means 20. Controlling means 22 is utilized to start or stop press 28 from remote location 18. Also, controlling means 22 can be utilized to lock press 28 so that press 28 can not be utilized by the customer until the owner unlocks press 28. Controlling means 22 is utilized when the customer defaults on payment to the owner or press 28 is utilized in a geographical location that the owner has determined and previously instructed or advised the customer is a no-use geographic zone.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An apparatus for calculating a usage fee for equipment, the apparatus comprising:
a monitoring means connected to equipment for monitoring usage of the equipment and creating equipment usage data;
a comparing means connected to said monitoring means for comparing said equipment usage data to a predetermined depreciation level to determine a corresponding depreciation level value; and
a calculating means connected to said comparing means for calculating an equipment usage fee, said equipment usage fee is calculated by combining said equipment usage data and said corresponding depreciation level value.

2. The apparatus in claim 1, further comprising:
a transmitting means connected to said monitoring means for transmitting said equipment usage data to a remote location, said transmitting means in communication with the remote location.

3. The apparatus in claim 2, wherein said transmitting means is connected to said calculating means for transmitting said equipment usage fee to the remote location.

4. The apparatus in claim 2, further comprising a storage means connected to said monitoring means for storing said equipment usage data.

5. The apparatus in claim 4, wherein said storage means is connected to said calculating means for storing said equipment usage fee.

6. The apparatus in claim 1, further comprising a controlling means in communication with said equipment for controlling operation of said equipment from a remote location, said controlling means locking said equipment to disable usage of said equipment and said controlling means unlocking said equipment to enable usage of said equipment.

7. The apparatus in claim 1, further comprising a location calculating means in communication with said equipment for calculating a location of said equipment, the location of said equipment is utilized to calculate said equipment usage fee.

8. The apparatus in claim 7, wherein said location calculating means is a global positioning system.

9. The apparatus in claim 1, wherein said equipment is a press.

10. The apparatus in claim 1, wherein said calculating means utilizes at least one of vibration level, vibration severity level, operating speed, operating torque, operating temperature, operating pressure, operating deflection, operating noise level, number of parts produced to calculate said equipment usage fee.

11. An apparatus for calculating a usage fee for equipment, the apparatus comprising:
a monitoring means connected to equipment for monitoring usage of said equipment and creating equipment usage data;
a comparing means connected to said monitoring means for comparing said equipment usage data to a predetermined depreciation level to determine a corresponding depreciation level value; and
a calculating means connected to said comparing means for calculating an equipment usage fee, said equipment usage fee is calculated by combining said equipment usage data and said corresponding depreciation level value, said equipment usage fee is at least one of increased and decreased based on said corresponding depreciation level value after said equipment usage fee is calculated.

12. The apparatus in claim 11, wherein said equipment is a press.

13. An apparatus for calculating a usage fee for a durable good, the apparatus comprising:
a durable good;
a monitoring means connected to said durable good for monitoring durable good usage and creating durable good usage data; and
a calculating means connected to said monitoring means for calculating a durable good usage fee based on said durable good usage data.

14. The apparatus in claim 13, further comprising:
a transmitting means connected to said monitoring means for transmitting said durable good usage data to a remote location, said transmitting means in communication with the remote location.

15. The apparatus in claim 14, wherein said transmitting means is connected to said calculating means for transmitting said durable good usage fee to the remote location.

16. The apparatus in claim 13, further comprising a storage means connected to said monitoring means for storing said durable good usage data.

17. The apparatus in claim 16, wherein said storage means is connected to said calculating means for storing said durable good usage fee.

18. The apparatus in claim 13, further comprising a controlling means in communication with said durable good for controlling operation of said durable good from a remote location, said controlling means locking said durable good to disable usage of said durable good and unlocking said durable good to enable usage of said durable good.

19. The apparatus in claim 13, wherein said calculating means utilizes at least one of vibration level, vibration severity level, operating speed, operating torque, operating temperature, operating pressure, operating deflection, operating noise level, operating time to calculate said durable good usage fee.

20. The apparatus in claim 13, further comprising a location calculating means in communication with said durable good for calculating a location of said durable good, the location of said durable good is utilized to calculate said durable good usage fee.

21. The apparatus in claim 20, wherein said location calculating means is a global positioning system.

22. A method for calculating a usage fee for equipment, the method comprising:
providing equipment;
monitoring said equipment;
creating equipment usage data based on said monitoring of said equipment;
comparing said equipment usage data to a predetermined depreciation level to determine a corresponding depreciation level value; and
calculating an equipment usage fee by combining said equipment usage data and said corresponding depreciation level value.

23. The method of claim 22, further comprising:
transmitting at least one of said equipment usage data equivalent location and said equipment usage fee to a remote location.

24. The method of claim 22, further comprising:
controlling operation of said equipment from a remote location.

25. The method of claim 24, further comprising:
locking said equipment to disable usage of said equipment from a remote location.

26. The method of claim 25, further comprising:
unlocking said equipment to enable usage of said equipment from a remote location.

27. The method of claim 22, further comprising:
storing at least one of said equipment usage data and said equipment usage fee.

28. The method of claim 22, further comprising:
calculating a location of said equipment for calculation of said equipment usage fee, the location of said equipment is utilized to calculate said equipment usage fee.

29. A method for calculating a usage fee for equipment, the method comprising:
providing equipment;
monitoring said equipment;
creating equipment usage data based on said monitoring of said equipment;
comparing said equipment usage data to a predetermined depreciation level to determine a corresponding depreciation level value; and
calculating an equipment usage fee by combining said equipment usage data and said corresponding depreciation level value, said equipment usage fee is at least one of increased and decreased based on said corresponding depreciation level value after said equipment usage fee is calculated.

30. A method for calculating a usage fee for a press, the method comprising:
providing a press;
creating press usage data for said press; and
calculating a press usage fee based on said press usage data.

31. The method of claim 30, further comprising:
transmitting at least one of said press usage data and said press usage fee to a remote location.

32. The method of claim 30, further comprising:
controlling operation of said press from a remote location.

33. The method of claim 32, further comprising:
locking said equipment to disable usage of said equipment from a remote location.

34. The method of claim 33, further comprising:
unlocking said equipment to enable usage of said equipment from a remote location.

35. The method of claim 30, further comprising:
storing at least one of said press usage data and said press usage fee.

36. The method of claim 30, further comprising:
calculating the location of said press for calculation of said press usage fee, the location of said press is utilized to calculate said press usage fee.

37. A method for calculating a usage fee for equipment, the method comprising:
providing equipment;
monitoring said equipment;
creating equipment usage data based on said monitoring of said equipment;
comparing said equipment usage data to a predetermined depreciation level to determine a corresponding depreciation level value; and
calculating an equipment usage fee by combining said equipment usage data and said corresponding depreciation level value, said equipment usage fee is at least one of increased and decreased based on said corresponding depreciation level value after said equipment usage fee is calculated, said equipment usage fee increased by an equipment availability fee.

38. The method of claim 37, further comprising:
transmitting at least one of said equipment usage data and said equipment usage fee to a remote location.

39. The method of claim 37, further comprising:
controlling operation of said equipment from a remote location.

40. The method of claim 39, further comprising:
locking said equipment to disable usage of said equipment from a remote location.

41. The method of claim 40, further comprising:
unlocking said equipment to enable usage of said equipment from a remote location.

42. The method of claim 37, further comprising:
storing at least one of said equipment usage data and said equipment usage fee.

43. The method of claim 37, further comprising:
calculating a location of said equipment for calculation of said equipment usage fee, the location of said equipment is utilized to calculate said equipment usage fee.

44. The method of claim 37, wherein said equipment is a press.
